(19) United States
(12) Patent Application Publication
(10) Pub. No.: US 2010/0236003 A1
(43) Pub. Date: Sep. 23, 2010

(54) Multi-use kitchen scraper- spatula

(76) Inventor: Eric Y. Teng, Gold River, CA (US)

Correspondence Address: ERIC Y. TENG;Nextrend Products, Suite A-8, 11300 Coloma Road, Gold River, CA, 95670, US

(21) Appl. No.: 12/383,044

(22) Filed: Mar. 18, 2009

(51) Int. Cl. A47L 17/00; A47L 17/06; A47J 43/28

(52) U.S. Cl. 15/105; 15/236.01; 294/7

(57) ABSTRACT

This invention presents a unique multi-use kitchen scraper-spatula that has four distinct edges made of three different materials having three different degrees of hardness or rigidity. This design transforms what is a common kitchen bowl scraper into a much more versatile cooking tool that can be used in the mixing, folding, and scraping of runny batter and sticky dough, the cutting and transfer of dough, as well as the removal of hardened food substance inside a bowl or on the counter.

### BACKGROUND—FIELD OF INVENTION

This invention relates to kitchen or cooking tools specifically a scraper for the scraping of a mixing bowl or kitchen counter, or a spatula for use in removing or transferring liquidly or sticky food substance.

### BACKGROUND—DESCRIPTION OF PRIOR ART

Traditional scrapers or spatulas are generally of two common types:

1) A low cost type that is of a one piece construction made by injection molding and constructed of a semi hard semi-flexible thermo plastic such as ABS, PP or polycarbonate. This is generally of a flat shape having some sides that may be curved or straight sharp edge suitable for use in scraping. On one side of it there is often a thickened frictional hand grip to allow the unit to be hand-held by a user during use. Scrapers of this design can be used for general, non-demanding purposes such as scraping off sticky dough or runny batter inside a bowl or scraping off hardened substance off of a kitchen counter. However, since the scraping edge is of a certain rigidity, it would be able to scrape the inside of a bowl quite as clean as using a spatula having a soft edge that can conform better with the inside contour of a bowl. Also it would be hard to be used to remove very tough hardened substance off of the kitchen counter such as spilt egg.

2) A higher cost type that is often constructed with a hard core made of metal etc with its outside constructed of a soft flexible thermo plastic such as silicone or TPE. The hard core serves to provide for rigidity to support the very flexible material implement to allow it to be used in bowl or counter scraping. This type of scraper or spatula is designed mainly for the scraping of more liquid material such as runny batter. But it would not be appropriate for use in scraping and removal of hardened food substance that is stuck to the bowl or counter top, a problem often encountered by a baker.

The type of dough or batter or food substance that a baker would encounter can range in degree of hardness from runny, almost liquid batter, butter, or egg, to moderately soft dough, or the very tough hardened dough or hardened solidified egg that is hard stuck on the counter or a rolling pin.

It can be seen that the type of scraper having soft, pliable edges can best be used for scraping of liquidly material, and the type of scraper with a one-piece semi-hard construction can be best used for the general scraping and the removal of moderately hardened dough. So in order to be able to handle both tasks, a user would have to acquire both kinds of scrapers. Still, even if both types of the two common scrapers or spatulas are readily available, still neither one of these is sufficiently tough to be used for the scraping and removal of very tough, hardened food substance that can be stubbornly stuck to the kitchen counter.

### BACKGROUND OF INVENTION—OBJECTS AND ADVANTAGES

The objects and advantages of the present invention are:
a) to provide a handy and compact implement for common kitchen tasks especially related to baking;
b) to provide a soft flexible edge that fits the contour of the inside of a bowl well enabling the scraping, folding and removal of runny batter;
c) to provide semi-hard plastic edges one with curved contour and one being straight suitable for general scraping of softer food substance and semi-hardened food substance that is stuck onto the inside of a bowl or the kitchen counter;
d) to provide a hard metal edge that is suitable for the removal of tough hardened food substance that is stuck to the surface of the kitchen counter;
e) to provide a rigid body with fairly sharp edges such that this implement can be used in cutting and transferring of dough.
f) To provide a simple and useful cooking implement that can be mass-produced efficiently and economically.

Still further objects and advantages will become apparent from a consideration of the ensuing descriptions and drawings.

### SUMMARY

In accordance with the present invention a scraper-spatula comprises a flat, palm-sized having three kinds of edges soft and flexible, semi-hard and semi-rigid, and hard metal shaped in forms suitable to be used in the scraping, removal, and transfer of food substance having various degree of softness (hardness) and stickiness.

### DRAWINGS

FIG. 1 shows a planar view of the scraper-spatula with various features as indicated

### DRAWINGS—REFERENCE NUMERALS

10 Frictional hand grip

20 Metal blade forming a hard edge

30 Sharpened edge of the main body forming a semi-hard semi-flexible curved edge

40 Soft and flexible edge forming a corner of the implement

50 Main body of the implement

60 Sharpened straight side forming a semi-hard semi-flexible straight edge

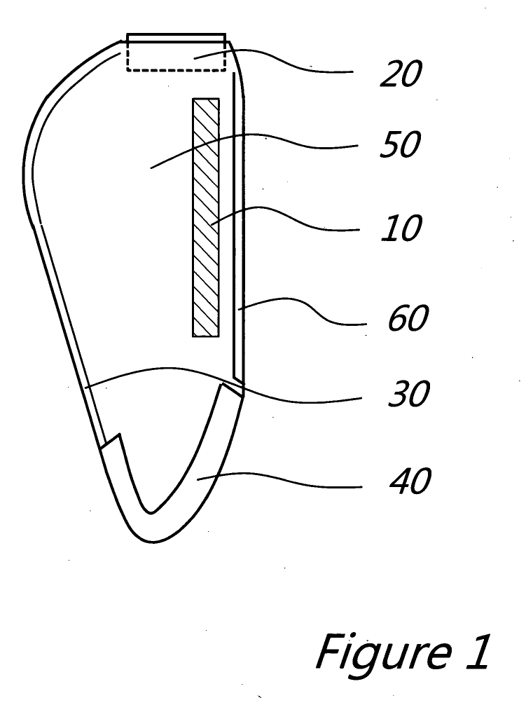

### DETAILED DESCRIPTION—FIG. 1 PREFERRED EMBODIMENT

Referring to FIG. 1 attached which shows the preferred embodiment of this invention: the kitchen scraper-spatula implement has a main body 50 made of hard (as compared to other plastics but not to metal) thermo plastic such as polypropylene, polycarbonate, ABS, nylon etc. On one side of the main body is shown having a beveled sharpened edge 30 which is a continuation of the main body that serves as a semi-hard semi-flexible scraping edge of the implement. The curvature and flexibility of this edge would allow this implement to be usable on many different surfaces whether curves or flat.

On the opposite side of sharpened edge 30 it is shown to have a hand grip 10 also an integral part of the main body that has some frictional design and it is generally thicker than surrounding area proving a secure convenient grip for a user's hand.

On another side of the implement, there is a thin metal blade 20 usually made of stainless steel molded into a protruding side of the main body. This metal blade thus will form a hard scraping edge of the implement.

On the direct opposite side of the metal blade 20 there is a flexible scraping edge 40 made of soft flexible thermoplastic material such as silicone, TPE, rubber etc. This scraping edge is forms a corner of the implement having somewhat an acute angle generally of less than 90 degrees. The flexible edge in this form can thus be used in similar manner as the head of a spatula for scraping the inside of a bowl.

Additionally, if the straight edge of the implement 60 close to the hand grip 10 is also sharpened, this would form a fourth edge of the scraper-spatula.

It can been seen that the four scraping edges, a soft flexible spatula head, a hard metal scraping edge and two semi-hard scraping edges one curved and one straight, would allow the scraper-spatula to have the best versatility in being able to be used to handle a multitude of kitchen tasks commonly encountered in baking and cooking.

Since the procedure in using the scraper-spatula is obvious and self-explanatory, no further discussion or explanation of this is provided herein.

What is claimed is:

1) A flat palm-sized kitchen implement complies of: a first edge made of a first material, said first material being soft and flexible; said first edge forms a soft and flexible corner of said implement shaped for scraping the inside of a bowl; a second edge made of a second material, said second material being substantially harder and more rigid than said first material; said second edge forms a curved edge being harder than said first edge; said first edge shaped to be suitable for general surface scraping; a third edge made of a third material; said third material being metal and substantially harder than said second material; said third edge shaped in a form suitable for scraping hardened substance stuck to the top of surfaces;
whereby said kitchen implement can be used to handle kitchen tasks related to baking and food handling.

2) A flat palm-sized kitchen implement complies of: a first edge made of a first material, said first material being soft and flexible; said first edge forms a soft and flexible corner of said implement shaped for scraping the inside of a bowl; a second edge made of a second material, said second material being substantially harder and more rigid than said first material; said second edge forms a curved edge harder than said first edge; said second edge shaped to be suitable for general surface scraping;
whereby said kitchen implement can be used to handle kitchen tasks related to baking and food handling.

3) A flat palm-sized kitchen implement complies of: a first edge made a first material, said first material being semi-hard and semi-rigid; said first edge shaped in a form suitable for general scraping; a second edge made of a second material; said second material being metal and substantially harder than said first material; said second edge being in a form suitable for scraping hardened substance stuck to top of surfaces;
whereby said kitchen implement can be used to handle kitchen tasks related to baking and food handling.
